(19) United States
(12) Patent Application Publication
(10) Pub. No.: US 2024/0248269 A1
(43) Pub. Date: Jul. 25, 2024

(54) OPTICAL WIRING COMPONENT, OPTICAL DEVICE, AND METHOD OF ASSEMBLING OPTICAL DEVICE

(71) Applicant: SUMITOMO ELECTRIC INDUSTRIES, LTD., Osaka-shi, Osaka (JP)

(72) Inventor: Tsutaru KUMAGAI, Osaka-shi (JP)

(73) Assignee: SUMITOMO ELECTRIC INDUSTRIES, LTD., Osaka-shi, Osaka (JP)

(21) Appl. No.: 18/562,593

(22) PCT Filed: Jun. 1, 2022
(86) PCT No.: PCT/JP2022/022375

§ 371 Date: Nov. 20, 2023

(30) Foreign Application Priority Data
Jun. 30, 2021 (JP) 2021-108532

(51) Int. Cl. G02B 6/43; G02B 6/42

(52) U.S. Cl. CPC G02B 6/43; G02B 6/424; G02B 6/428

(57) ABSTRACT

An optical wiring component includes an optical fiber having a first end portion and a second end portion, an optical connector configured on a base and configured to hold the first end portion, and an optical connection member configured to hold the second end portion. The optical fiber includes one or a plurality of optical fibers. The optical connector includes one or a plurality of optical connectors. The optical connector includes a terminal member configured to expose the first end portion, and a changing mechanism configured to restrict movement of the optical connector with respect to the base in a first direction and enable movement of the optical connector with respect to the base in a second direction intersecting the first direction

### TECHNICAL FIELD

The present disclosure relates to an optical wiring component, an optical device, and a method of assembling an optical device. This application claims priority based on Japanese Patent Application No. 2021-108532 filed on Jun. 30, 2021, and the entire contents of the Japanese patent application are incorporated herein by reference.

### BACKGROUND ART

Patent Literature 1 (PTL 1) discloses an optical wiring component connected to a circuit board. For example, the optical wiring component includes an optical fiber. The optical wiring component is disposed at a base provided with a circuit board and other components

### CITATION LIST

### Patent Literature

PTL 1: Japanese Unexamined Patent Application Publication No. 2016-71025

### SUMMARY OF INVENTION

An optical wiring component according to the present disclosure includes an optical fiber, an optical connector, and an optical connection member. The optical fiber has a first end portion and a second end portion. The optical fiber includes one or a plurality of optical fibers. The optical connector is configured to be provided on a base and configured to hold the first end portion. The optical connector includes one or a plurality of optical connectors. The optical connection member is configured to hold the second end portion. The optical connector includes a terminal member and a changing mechanism. The terminal member is configured to expose the first end portion. The changing mechanism is configured to restrict movement of the optical connector with respect to the base in a first direction and enable movement of the optical connector with respect to the base in a second direction intersecting the first direction.

An optical device according to the present disclosure includes the optical wiring component, an optical integrated circuit, and a base. The optical integrated circuit is optically connected to the optical connection member. The optical integrated circuit and the optical wiring component are disposed at the base.

A method of assembling an optical device according to the present disclosure is attaching the optical wiring component to the base.

### BRIEF DESCRIPTION OF THE DRAWINGS

FIG. 1 is a schematic view of an optical device according to an embodiment.

FIG. 2 is an enlarged partial view of the optical device.

FIG. 3 is a perspective view of an optical connector in an optical wiring component.

FIG. 4 is a perspective view of a positioning member in the optical wiring component.

FIG. 5 is a diagram illustrating an example of a configuration of an optical connection member in the optical wiring component.

FIG. 6 is a diagram illustrating an optical wiring component according to a modification of the embodiment.

FIG. 7 is a diagram illustrating an optical wiring component according to a modification of the embodiment.

FIG. 8 is a diagram illustrating an optical wiring component according to a modification of the embodiment.

FIG. 9 is a diagram illustrating an optical wiring component according to a modification of the embodiment.

FIG. 10 is a diagram illustrating an optical wiring component according to a modification of the embodiment.

FIG. 11 is a diagram illustrating an optical wiring component according to a modification of the embodiment.

FIG. 12 is a diagram illustrating an optical wiring component according to a comparative example.

### DETAILED DESCRIPTION

### Problems to be Solved by Present Disclosure

In a case where a general-purpose optical fiber is connected to a circuit board, a connection portion between the optical fiber and the circuit board may be thermally deformed due to heat generated by the circuit board. Suppressing the thermal deformation of the connection portion between the optical fiber and the circuit board ensures the reliability of the optical coupling. For this reason, an optical wiring component has been studied in which an optical connection member formed of a heat-resistant material or structure is provided at one end of the optical fiber connected to the circuit board, and an optical connector configured to be connected to the general-purpose optical fiber is provided at the other end of the optical fiber.

When the optical wiring component having the above configuration is attached to the base, each of the optical connection member and the optical connector is fixed to the base. Since the length of the optical fiber between the optical connection member and the optical connector needs an extra length to absorb a manufacturing error, the optical fiber fixed to the base by the optical connection member and the optical connector is bent due to the extra length. When a curvature of bending is large, the reliability of the optical coupling between the optical fiber and the circuit is lowered. Therefore, strict precision is required with respect to the arrangement of the optical connection member and the optical connector and the length of the optical fiber so as to reduce degradation of reliability of the optical coupling, and affects productivity as well.

### Advantageous Effects of Present Disclosure

According to the present disclosure, it is possible to provide an optical wiring component, an optical device, and a method of assembling an optical device in which bending of an optical fiber can be reduced.

### Description of Embodiments of Present Disclosure

First, embodiments according to the present disclosure will be listed and explained.

An optical wiring component according to the present disclosure includes an optical fiber, an optical connector, and an optical connection member. The optical fiber has a first end portion and a second end portion. The optical fiber includes one or a plurality of optical fibers. The optical connector is configured to be provided on a base and configured to hold the first end portion. The optical connection member is configured to hold the second end portion. The optical connector includes a terminal member and a changing mechanism. The terminal member is configured to expose the first end portion. The changing mechanism is configured to restrict movement of the optical connector with respect to the base in a first direction and enable movement of the optical connector with respect to the base in a second direction intersecting the first direction.

In the optical wiring component, the changing mechanism is configured to restrict movement of the optical connector with respect to the base in the first direction and enable movement of the optical connector with respect to the base in the second direction. Therefore, even after the optical connection member and the optical connector are attached to the base, the bending of the optical fiber can be eliminated by the movement of the optical connector in the second direction by the changing mechanism.

The optical wiring component may further include a positioning member configured to engage with the changing mechanism of the optical connector and position the optical connector with respect to the base. The changing mechanism may be configured to restrict movement of the optical connector with respect to the positioning member in the first direction and enable relative movement of the optical connector with respect to the positioning member in the second direction. In this case, the optical connector can be more easily and reliably positioned with respect to the base by the positioning member, and the bending of the optical fiber can be eliminated by the movement of the optical connector in the second direction.

The changing mechanism and the positioning member may further include a locking mechanism configured to lock movement of the optical connector with respect to the positioning member. The locking mechanism may be configured to lock movement of the optical connector toward the optical connection member in the second direction. In this case, the optical connector can be fixed at a position where no bending of the optical fiber occurs.

The locking mechanism may include a plurality of first claw portions and a second claw portion. The plurality of first claw portions may be included in one of the changing mechanism and the positioning member. The second claw portion may be included in the other one of the changing mechanism and the positioning member. The plurality of first claw portions may be arranged in the second direction. The second claw portion may be configured to restrict movement of the optical connector with respect to the positioning member by coming into contact with any of the plurality of first claw portions. In this case, a position at which the optical connector is locked changes according to a positional relationship between the first claw portions and the second claw portion which come in contact with each other. Therefore, the optical connector can be more reliably fixed at a position where no bending of the optical fiber occurs.

The plurality of first claw portions and the second claw portion may be configured to restrict by coming into contact with each other movement of the optical connector with respect to the positioning member in a direction toward the optical connection member and allow by sliding on each other movement of the optical connector in a direction in which the optical connection member and the optical connector separate from each other. In this case, the movement of the optical connector in a direction in which the bending of the optical fiber is eliminated is allowed, while the movement of the optical connector in a direction in which the bending of the optical fiber occurs is restricted. Therefore, the bending of the optical fiber can be eliminated more easily and reliably.

The positioning member further may include a curved portion. The curved portion may configured to be displaced in a third direction intersecting the first direction and the second direction.

The changing mechanism may include a through opening extending through the optical connector in the second direction. The positioning member may be fitted into the through opening and includes a slide surface configured to slide with respect to a surface defining the through opening.

The optical wiring component may further include a locking member configured to lock movement of the optical connector with respect to the positioning member. The locking member may be configured to lock movement of the optical connector toward the optical connection member in the second direction. In this case, the optical connector can be fixed at a position where no bending of the optical fiber occurs.

The locking member may include a pin member. The pin member may be fixed to one of the positioning member and the optical connector. The pin member may be configured to, in a state of being fixed to one of the positioning member and the optical connector, engage with the other one of the positioning member and the optical connector in the second direction and lock movement of the optical connector toward the optical connection member. In this case, the optical connector can be fixed at a position where no bending of the optical fiber occurs by an easier operation.

The locking member may include a screw. The screw may be screwed into one of the positioning member and the optical connector. The screw may include a tip configured to move with respect to the positioning member and the optical connector in response to turning of the screw. The tip may be configured to engage with the other one of the positioning member and the optical connector and lock movement of the optical connector toward the optical connection member. In this case, the optical connector can be fixed at a position where no bending of the optical fiber occurs by an easy operation using the screw.

The tip may be configured to move in the second direction in response to turning of the screw. In this case, the fixing position of the optical connector can be adjusted, by turning the screw, with a higher precision to a position where no bending of the optical fiber occurs.

The tip may be configured to move in the first direction in response to turning of the screw.

The locking member may include an urging member. The urging member may be fixed to one of the positioning member and the optical connector. The urging member may be configured to urge the optical connector in a direction in which the optical connection member and the optical connector separate from each other in the second direction. In this case, an urging force of the urging member can reduce the occurrence of the bending of the optical fiber and reduce a force applied to a connection portion of the optical connection member due to the bending of the optical fiber.

The urging member may include a coil spring. The coil spring may have one end fixed to one of the optical connector and the positioning member. The coil spring may have the other end in contact with the other one of the optical connector and the positioning member.

The urging member may be configured to urge the optical connector with an urging force of 5 N or more.

The optical connector may be configured to hold the first end portion of the optical fiber such that the first end portion extends in the second direction in the optical connector. In this case, adjusting the position of the optical connector in the second direction can more reliably reduce the bending of the optical fiber.

The one or plurality of optical fibers may include a first optical fiber and a second optical fiber. Each of the first optical fiber and the second optical fiber may include the first end portion and the second end portion. The one or plurality of optical connectors may include a first optical connector and a second optical connector. The first optical connector may be configured to hold the first end portion of the first optical fiber. The second optical connector may be configured to hold the first end portion of the second optical fiber. The optical connection member may be configured to hold the second end portion of each of the first optical fiber and the second optical fiber. In this case, the bending can be reduced in each of the optical fibers of different optical connectors connected to one optical connection member.

The optical fiber may have a length of 20 mm to 100 mm. In this case, a thermal influence on the optical connector can be reduced, and a space for arranging the optical wiring component can be reduced. Therefore, the reliability of optical coupling can be improved by a compact configuration.

An optical device according to the present disclosure includes the optical wiring component, an optical integrated circuit, and a base. The optical integrated circuit is optically connected to the optical connection member. The optical integrated circuit and the optical wiring component are disposed at the base. In this case, an influence of heat from the optical integrated circuit on the optical connector is reduced, and the bending of the optical fiber is reduced.

A method of assembling an optical device according to the present disclosure includes attaching the optical wiring component to the base.

### Details of Embodiments of Present Disclosure

Specific examples of an optical wiring component and an optical device according to an embodiment of the present disclosure will be described below with reference to the drawings. The optical wiring component and the optical device of the present disclosure are not limited to these examples, but are defined by the scope of the claims, and are intended to include all modifications within the meaning and scope equivalent to the scope of the claims. In the following description, the same elements are denoted by the same reference numerals in the description of the drawings, and redundant description thereof will be omitted.

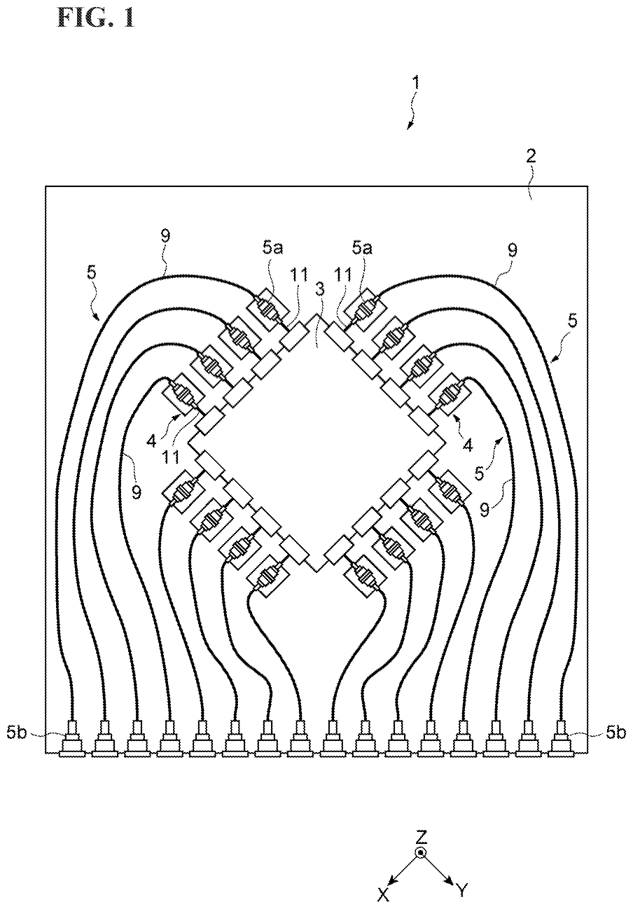

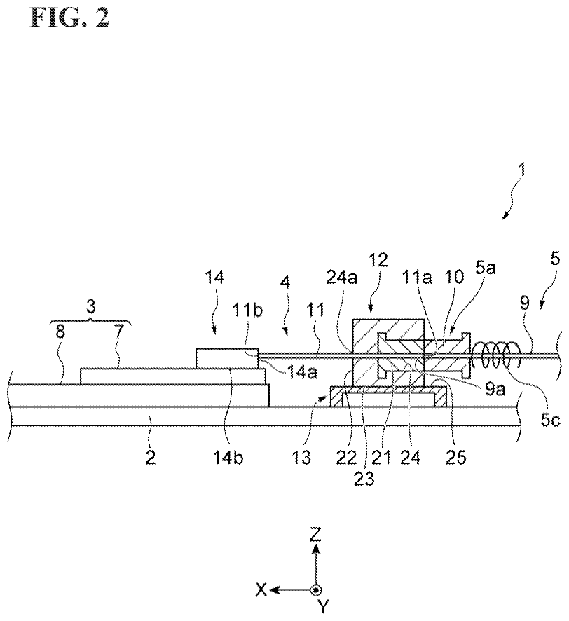

Referring to FIGS. 1 and 2, the configurations of an optical device and an optical wiring component according to an embodiment of the present disclosure will be described. FIG. 1 is a schematic diagram of the optical device according to the embodiment. FIG. 2 is an enlarged partial view of the optical device according to the embodiment.

An optical device 1 is a device that performs an arithmetic processing in accordance with input light. Optical device 1 inputs or outputs information with light. Optical device 1 includes a base 2, an optical integrated circuit 3, an optical wiring component 4, and an optical cable 5. Optical integrated circuit 3 performs an arithmetic processing based on information input with light.

Base 2 is a base member at which various members of optical device 1 are disposed. Optical integrated circuit 3, optical wiring component 4, and optical cable 5 are disposed at base 2. Base 2 is a substrate. For example, base 2 is a printed circuit board (PCB).

Optical integrated circuit 3 is, for example, a co-packaged optics (CPO). The CPO is a switch in which electrical and optical components are combined to each other. Optical integrated circuit 3 includes an optical processor 7 and an electrical processor 8 as shown in FIG. 2. Optical processor 7 performs a processing on an input optical signal. Optical processor 7 includes, for example, a light receiving element. Electrical processor 8 performs a processing on an input electrical signal. For example, the optical signal input to optical processor 7 is converted into an electrical signal and then input to electrical processor 8. Electrical processor 8 is disposed on base 2 and is in contact with base 2. Optical processor 7 is disposed on electrical processor 8 and is in contact with electrical processor 8. Electrical processor 8 is disposed between base 2 and optical processor 7.

Optical wiring component 4 is configured to transmit light. Optical wiring component 4 is disposed so as to be in contact with base 2 and optical integrated circuit 3. Optical wiring component 4 is fixed to base 2 and optical integrated circuit 3. Optical wiring component 4 optically connects optical cable 5 and optical processor 7 of optical integrated circuit 3 to each other. For example, optical wiring component 4 transmits an optical signal output from optical cable 5 to optical processor 7 and transmits an optical signal output from optical processor 7 to optical cable 5.

Optical cable 5 is configured to transmit light. Optical cable 5 is fixed to base 2. As shown in FIG. 1, optical cable 5 includes a pair of end portions 5a and 5b. End portion 5a is optically connected to optical wiring component 4. As shown in FIG. 2, end portion 5b is urged by an urging member 5c against optical wiring component 4. Urging member 5c is, for example, a spring. End portion 5b is an output terminal of optical device 1. Optical cable 5 is optically connected to optical wiring component 4 at end portion 5a. Therefore, the optical signal input to end portion 5b is input to optical wiring component 4 through end portion 5a.

Optical cable 5 includes an optical fiber 9 and a pair of terminal members 10. Optical fiber 9 includes a pair of end portions 9a. The pair of end portions 9a are each held by a corresponding one of terminal members 10. Each of terminal members 10 is, for example, a ferrule. Each of terminal members 10 is formed of, for example, a plastic resin. Each of end portions 9a is exposed from the holding one of terminal members 10. A pair of end portions 5a and 5b each include one of end portions 9a and one of terminal members 10. The pair of end portions 5a and 5b have a same configuration. The pair of end portions 5a and 5b have, for example, a same shape.

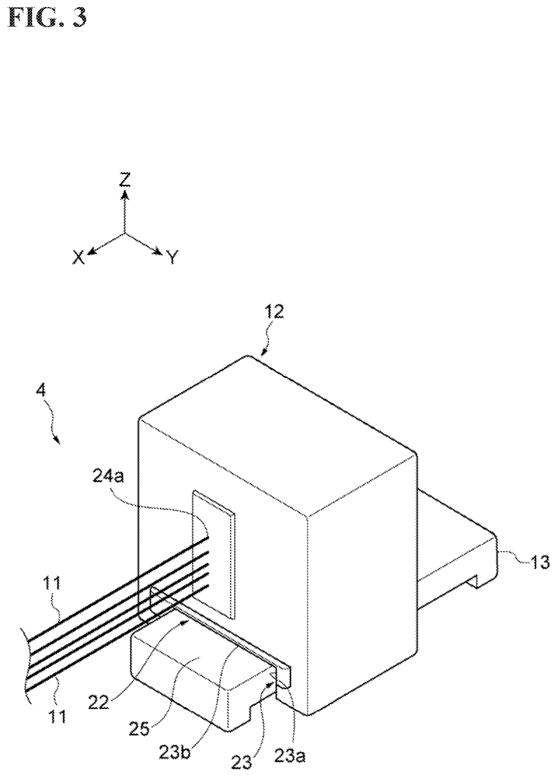

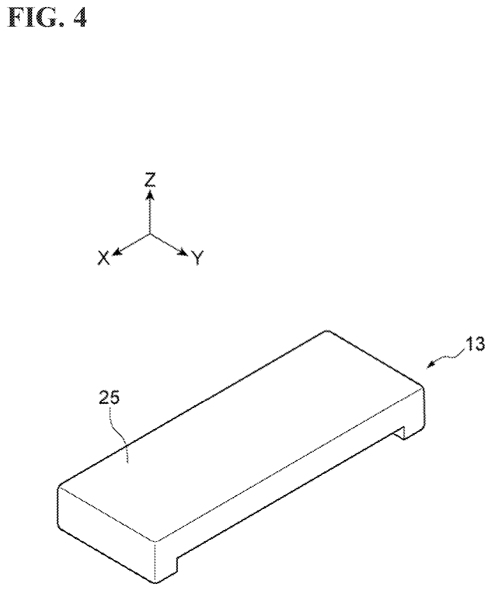

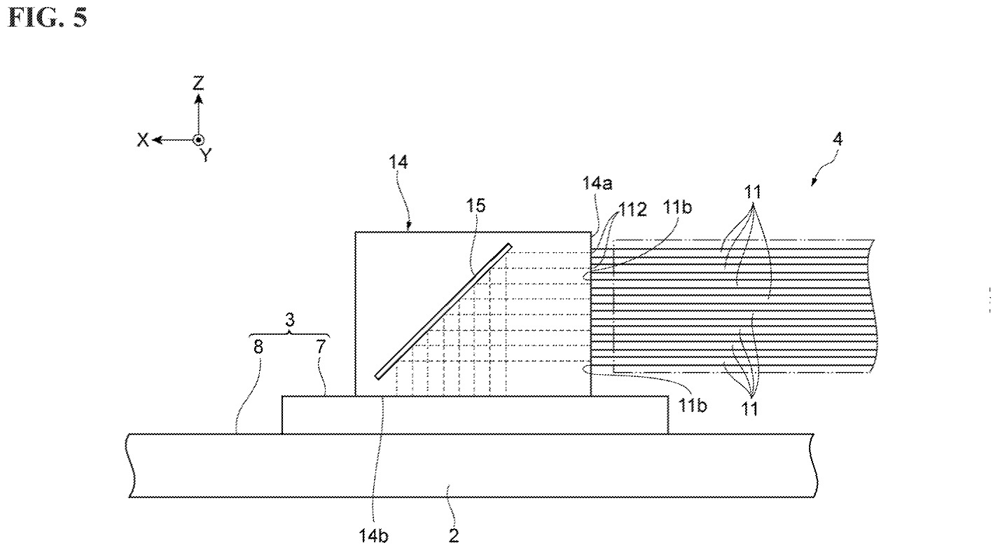

Referring to FIGS. 2 to 5, optical wiring component 4 will be described in more detail. Optical wiring component 4 includes an optical fiber 11, an optical connector 12, a positioning member 13, and an optical connection member 14. In FIGS. 2 to 5, an X-axis, a Y-axis and a Z-axis are orthogonal to one another. The Z-axis is along a thickness direction of base 2. Optical connector 12 and optical connection member 14 are arranged in an X-axis direction. FIG. 3 is a perspective view of optical connector 12 in the optical wiring component. FIG. 4 is a perspective view of positioning member 13 in optical wiring component 4. FIG. 5 is a diagram illustrating an example of a configuration of optical connection member 14 in optical wiring component 4.

Optical fiber 11 includes a pair of end portions 11a and 11b. When end portion 11a corresponds to the first end portion, end portion 11b corresponds to the second end portion. The length of optical fiber 11 is shorter than that of optical fiber 9 of optical cable 5. Optical fiber 11 has a length of 20 mm to 100 mm, for example. In the present embodiment, as shown in FIGS. 3 and 5, optical wiring component 4 includes a plurality of optical fibers 11 extending in a same direction and parallel to each other. In FIG. 2, for convenience, only one of optical fibers 11 is shown, and the other optical fibers 11 are omitted.

Optical connector 12 is configured to be provided on base 2 as shown in FIG. 2. Optical connector 12 is configured to move in the X-axis direction. Optical connector 12 is configured to hold end portion 11a of optical fiber 11. Optical connector 12 is configured to hold end portion 11a so that end portion 11a of optical fiber 11 extends in the X-axis direction in optical connector 12. Optical connector 12 includes a terminal member 21 and a changing mechanism 22. In the present embodiment, optical connector 12 is configured to hold a plurality of optical fibers 11. The plurality of optical fibers 11 extend in a same direction.

Terminal member 21 is configured to hold end portion 11a of optical fiber 11. Terminal member 21 is configured to expose end portion 11a. Terminal member 21 is connected to one of terminal members 10 of optical cable 5. End portion 11a of optical fiber 11 is connected to one of end portions 9a of optical fiber 9. Terminal member 21 is, for example, a ferrule. Terminal member 21 is formed of, for example, a plastic resin. In the present embodiment, the plurality of optical fibers 11 held by optical connector 12 are held by one terminal member 21.

Changing mechanism 22 is configured to restrict movement of optical connector 12 with respect to base 2 in a Y-axis direction and a Z-axis direction and enable movement of optical connector 12 with respect to base 2 in the X-axis direction. Changing mechanism 22 is configured to restrict movement of optical connector 12 with respect to positioning member 13 in the Y-axis direction and the Z-axis direction. Changing mechanism 22 is configured to enable relative movement of optical connector 12 with respect to positioning member 13 in the X-axis direction. In the present embodiment, as shown in FIG. 3, changing mechanism 22 includes a through opening 23 extending through optical connector 12 in the X-axis direction.

In the present embodiment, as shown in FIG. 2, changing mechanism 22 is a housing and includes a housing portion 24 that houses terminal member 21. Terminal member 21 is held by housing portion 24. Housing portion 24 has a through hole 24a. Optical fiber 11 extending from terminal member 21 passes through through hole 24a. In other words, optical fiber 11 extends from terminal member 21 toward optical connection member 14 passing through through hole 24a. In a modification of the present embodiment, changing mechanism 22 may be integrally formed with terminal member 21.

As shown in FIG. 3, for example, through opening 23 is defined by a pair of surfaces 23a facing each other in the Y-axis direction and a pair of surfaces 23b connecting the pair of surfaces 23a to each other. Each of the pair of surfaces 23a and the pair of surfaces 23b includes a flat surface. Positioning member 13 is in contact with the pair of surfaces 23a and one of surfaces 23b.

Positioning member 13 is configured to position optical connector 12 with respect to base 2. Positioning member 13 is configured to engage with changing mechanism 22 of optical connector 12. As shown in FIG. 4, positioning member 13 extends in the X-axis direction. In the present embodiment, as shown in FIG. 3, positioning member 13 is fitted into through opening 23. Positioning member 13 has a rectangular shape when viewed from the Z-axis direction. Positioning member 13 includes a slide surface 25 extending in the X-axis direction when viewed from the Z-axis direction. Slide surface 25 is in contact with one of surfaces 23b of optical connector 12 and is configured to slide with respect to the one of surface 23b. Slide surface 25 has, for example, a rectangular shape, and a longitudinal direction of slide surface 25 is parallel to the X-axis direction. In the present embodiment, positioning member 13 is in contact with base 2.

Optical connection member 14 is configured to be provided above base 2 as shown in FIG. 5. Optical connection member 14 is configured to hold end portion 11b of optical fiber 11. Optical connection member 14 optically connects end portion 11b of optical fiber 11 to optical processor 7 of optical integrated circuit 3. Optical connection member 14 is in contact with optical processor 7 of optical integrated circuit 3. Optical connection member 14 has heat resistance. Optical connection member 14 is formed of glass. In the present embodiment, optical connection member 14 is configured to hold the plurality of optical fibers 11 extending parallel to each other which are connected to a same optical connector 12.

In the present embodiment, optical connection member 14 includes a joint surface 14a to which end portion 11b of optical fiber 11 is to be joined. Optical fiber 11 is held by optical connection member 14 by bonding end portion 11b and joint surface 14a to each other. Optical connection member 14 includes a joint surface 14b to be joined to optical processor 7 of optical integrated circuit 3. For example, joint surface 14a and joint surface 14b are orthogonal to each other. Optical connection member 14 is optically connected to end portion 11b of optical fiber 11. Optical connection member 14 is optically connected to optical processor 7 of optical integrated circuit 3.

Optical connection member 14 further includes a light reflection portion 15. Light reflection portion 15 is configured to guide light incident on joint surface 14a to joint surface 14b. Light reflection portion 15 is configured to guide light incident on joint surface 14b to joint surface 14a. Optical connection member 14 is configured to guide light emitted from end portion 11b of optical fiber 11 to optical processor 7 through light reflection portion 15. Optical connection member 14 is configured to guide light emitted from optical processor 7 to end portion 11b of optical fiber 11 through light reflection portion 15. In this manner, optical connection member 14 optically connects and couples end portion 11b of optical fiber 11 and optical processor 7 to each other. Optical fiber 11 extends linearly from optical connector 12 to optical connection member 14, for example.

Optical wiring component 4 having the above-described configuration is attached to base 2 at which optical integrated circuit 3 is disposed. In optical wiring component 4, after optical connection member 14 is attached to optical integrated circuit 3, optical connector 12 is attached to base 2 with positioning member 13 interposed therebetween. In the present embodiment, in attaching optical wiring component 4, positioning member 13 is attached to base 2 after being attached to optical connector 12. As a modification of the present embodiment, in attaching optical wiring component 4, optical connector 12 may be attached to positioning member 13 after positioning member 13 is attached to base 2. Optical connector 12 may be directly attached to base 2 so as to be movable in the X-axis direction with respect to base 2.

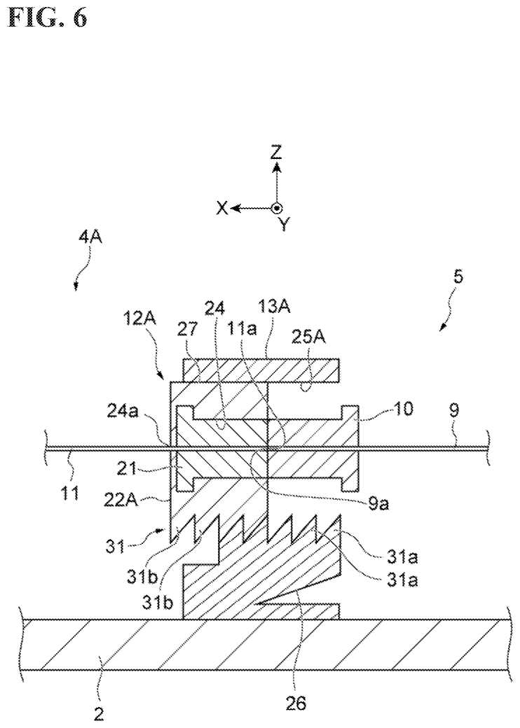

Referring to FIG. 6, an optical wiring component in a modification of the present embodiment will be described. FIG. 6 is a diagram illustrating the optical wiring component in the modification of the embodiment. This modification is generally similar to or the same as the embodiment described above. An optical wiring component 4A in this modification is different from that in the above-described embodiment in that an optical connector 12A is included instead of optical connector 12 and a positioning member 13A is included instead of positioning member 13. Hereinafter, differences between this modification and the above-described embodiment will be mainly described.

In this modification, optical connector 12A is configured to hold at least one optical fiber 11. In FIG. 6, only one optical fiber 11 is shown. However, a plurality of optical fibers 11 may be held by optical connector 12A. Optical connector 12A includes a changing mechanism 22A instead of changing mechanism 22. In this modification, changing mechanism 22A is configured to restrict movement of optical connector 12A with respect to base 2 in the Y-axis direction and the Z-axis direction and enable movement of optical connector 12A with respect to base 2 in the X-axis direction. Changing mechanism 22A is configured to restrict movement of optical connector 12A with respect to positioning member 13A in the Y-axis direction and the Z-axis direction. Changing mechanism 22A is configured to enable relative movement of optical connector 12A with respect to positioning member 13A in the X-axis direction. In this modification, changing mechanism 22A is a housing and includes housing portion 24 that houses terminal member 21. Changing mechanism 22A may be integrally formed with terminal member 21.

Changing mechanism 22A and positioning member 13A further include a locking mechanism 31. Locking mechanism 31 is formed of a combination of changing mechanism 22A and positioning member 13A. In other words, locking mechanism 31 is formed of optical connector 12A and positioning member 13A.

Locking mechanism 31 is configured to lock the movement of optical connector 12A with respect to positioning member 13A. In the present specification, “lock movement” means restricting movement by direct or indirect contact, that is, restricting movement from occurring. Optical connector 12A and optical connection member 14 are arranged in the X-axis direction. Locking mechanism 31 is configured to lock movement of optical connector 12A toward optical connection member 14 in the X-axis direction. In other words, locking mechanism 31 is configured to lock movement of optical connector 12A in a direction in which optical fiber 11 extends from optical connector 12A.

Locking mechanism 31 includes a plurality of first claw portions 31a and a plurality of second claw portions 31b. The plurality of first claw portions 31a are included in one of changing mechanism 22A and positioning member 13A. The plurality of second claw portions 31b are included in the other one of changing mechanism 22A and positioning member 13A. In this modification, the plurality of first claw portions 31a are included in positioning member 13A. The plurality of second claw portions 31b are included in changing mechanism 22A. In a further modification of this modification, the number of second claw portions 31b included in one of changing mechanism 22A and positioning member 13A may be one.

The plurality of first claw portions 31a are arranged in the X-axis direction. Second claw portion 31b is configured to restrict movement of optical connector 12A with respect to positioning member 13A by coming into contact with any of the plurality of first claw portions 31a. The plurality of first claw portions 31a and second claw portion 31b are configured to restrict by coming into contact with each other movement of optical connector 12A with respect to positioning member 13A in a direction toward optical connection member 14. The plurality of first claw portions 31a and second claw portion 31b are configured to allow by sliding on each other movement of optical connector 12A in a direction in which optical connection member 14 and optical connector 12A separate from each other. Terminal member 10 is configured to move together with optical connector 12A in a state where end portion 9a of optical fiber 9 and end portion 11a of optical fiber 11 are optically connected.

In this modification, positioning member 13A further includes a slide surface 25A extending in the X-axis direction when viewed from the Z-axis direction and a curved portion 26 configured to be displaced in the Z-axis direction. Changing mechanism 22A includes a surface 27 on a side opposite to locking mechanism 31. Surface 27 is in contact with slide surface 25A. Positioning members 13A interposes changing mechanism 22A in the Z-axis direction. For example, slide surface 25A and the plurality of first claw portions 31a interpose changing mechanism 22A in the Z-axis direction.

In this modification, as changing mechanism 22A moves with respect to positioning member 13A, surface 27 and slide surface 25A slide relative to each other. Curved portion 26 is curved in a state in which an urging force is generated in the Z-axis direction when the plurality of first claw portions 31a and second claw portion 31b slide on each other.

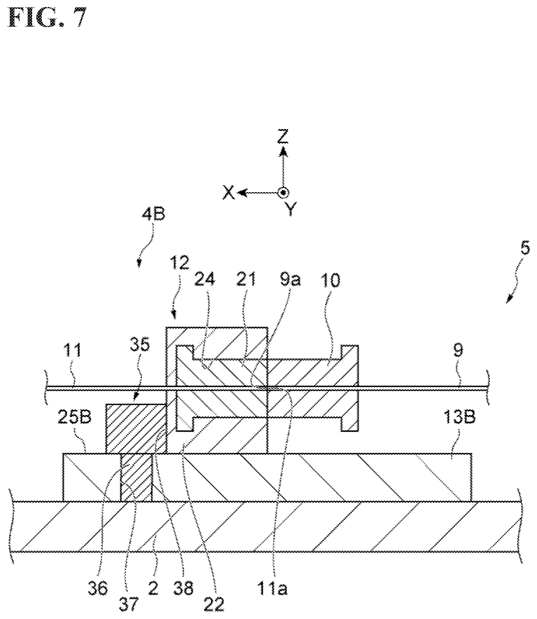

Referring to FIG. 7, an optical wiring component in a modification of the present embodiment will be described. FIG. 7 is a diagram illustrating the optical wiring component in the modification of the embodiment. This modification is generally similar to or the same as the embodiment described above. An optical wiring component 4B in this modification is different from the above-described embodiment in that positioning member 13B is included instead of positioning member 13 and a locking member 35 is further included. Hereinafter, differences between this modification and the above-described embodiment will be mainly described.

In this modification, optical connector 12 is configured to hold at least one optical fiber 11. Only one optical fiber 11 is shown in FIG. 7. However, a plurality of optical fibers 11 may be held by optical connector 12.

Locking member 35 is configured to lock movement of optical connector 12 with respect to positioning member 13B. Locking member 35 is configured to lock movement of optical connector 12 toward optical connection member 14 in the X-axis direction. In other words, locking member 35 is configured to lock movement of optical connector 12 in a direction in which optical fiber 11 extends from optical connector 12.

Locking member 35 includes at least one pin member 36. Pin member 36 is fixed to one of positioning member 13B and optical connector 12. Pin member 36 is configured to, in a state of being fixed to one of positioning member 13B and optical connector 12, engage with the other one of positioning member 13B and optical connector 12 in the X-axis direction and lock movement of optical connector 12 toward optical connection member 14.

For example, positioning member 13B includes at least one through opening 37. Pin member 36 is inserted in through opening 37 to be fixed to positioning member 13B. For example, changing mechanism 22 includes a contact surface 38 that is orthogonal to the X-axis direction. Contact surface 38 faces optical connection member 14. Optical fiber 11 extends from contact surface 38. Pin member 36 is configured to, in a state of being disposed in through opening 37, come into contact with contact surface 38 of changing mechanism 22 of optical connector 12 and lock the movement of optical connector 12. Terminal member 10 is configured to move together with optical connector 12 in a state in which end portion 9a of optical fiber 9 and end portion 11a of optical fiber 11 are optically connected.

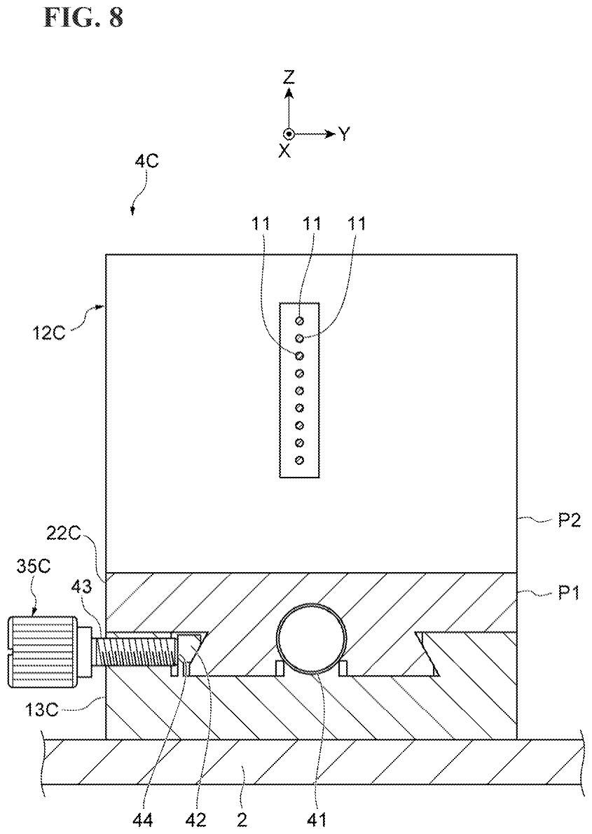

Referring to FIG. 8, an optical wiring component in a modification of the present embodiment will be described. FIG. 7 is a diagram illustrating the optical wiring component in the modification of the embodiment. This modification is generally similar to or the same as the modification described with reference to FIG. 7. An optical wiring component 4C in this modification is different from the above-described embodiment in that an optical connector 12C is included instead of optical connector 12, a positioning member 13C is included instead of positioning member 13B, and a locking member 35C is included instead of locking member 35. Hereinafter, differences between this modification and the above-described embodiment will be mainly described.

In this modification, optical connector 12C is configured to hold at least one optical fiber 11. A plurality of optical fibers 11 is held by optical connector 12C in FIG. 8. However, only one optical fiber 11 may be held by optical connector 12C. In FIG. 8, nine optical fibers 11 are held by optical connector 12C. Optical connector 12C includes a changing mechanism 22C instead of changing mechanism 22. Furthermore, in this modification, changing mechanism 22C is configured to restrict movement of optical connector 12C with respect to base 2 in the Y-axis direction and the Z-axis direction and enable movement of optical connector 12C with respect to base 2 in the X-axis direction. Changing mechanism 22C is configured to restrict movement of optical connector 12C with respect to positioning member 13C in the Y-axis direction and the Z-axis direction. Changing mechanism 22C is configured to enable relative movement of the optical connector 12C with respect to positioning member 13C in the X-axis direction. In this modification, changing mechanism 22C is a housing and includes housing portion 24 that houses terminal member 21, which is the same as the configuration of changing mechanism 22 shown in FIG. 2. Changing mechanism 22C may be integrally formed with terminal member 21.

Changing mechanism 22C is configured to slide in the X-axis direction with respect to positioning member 13C. In this modification, changing mechanism 22C includes a rail 41 extending in the X-axis direction. Changing mechanism 22C slides with rail 41 with respect to positioning member 13C. In a further modification of this modification, rail 41 may be included in positioning member 13C. In this case, changing mechanism 22C slides along rail 41. In this modification, a part P1 of changing mechanism 22 that slides with respect to positioning member 13C is formed separately from a part P2 having housing portion 24. These parts P1 and P2 are joined to each other with, for example, an adhesive or a mechanical structure (not shown).

Positioning member 13C includes a contact portion 42. Contact portion 42 is configured to be displaced in the Y-axis direction in response to an external force and come into contact with changing mechanism 22C.

Locking member 35C is configured to lock movement of optical connector 12C with respect to positioning member 13C. Locking member 35C is configured to lock movement of optical connector 12C toward optical connection member 14 in the X-axis direction. In other words, locking member 35C is configured to lock movement of optical connector 12C in a direction in which optical fiber 11 extends from optical connector 12C.

Locking member 35C includes a screw 43. Screw 43 is screwed into one of positioning member 13C and optical connector 12C. In the present specification, “screwing” means a state in which parallel movement is restricted when turning of screw 43 is stationary, and includes a state in which screw 43 moves in response to turning. Screw 43 includes a tip 44. Tip 44 is configured to move with respect to positioning member 13C and optical connector 12C in response to turning of screw 43. Screw 43 extends in the Y-axis direction. Tip 44 is configured to move in the Y-axis direction in response to turning of screw 43. Tip 44 is configured to engage with the other one of positioning member 13C and optical connector 12C and lock movement of optical connector 12C toward optical connection member 14.

In this modification, screw 43 is fixed to positioning member 13C. For example, a screw portion of screw 43 comes into contact with positioning member 13C to restrict movement of screw 43. Tip 44 moves in the Y-axis direction to displace contact portion 42. Accordingly, screw 43 applies a frictional force to changing mechanism 22C through contact portion 42 in response to turning of screw 43. As a result, the movement of optical connector 12C toward optical connection member 14 is locked.

In a further modification of this modification, changing mechanism 22C may include contact portion 42. In this case, contact portion 42 is displaced in the Y-axis direction in response to an external force and comes into contact with positioning member 13C. Screw 43 applies a frictional force to positioning member 13C through contact portion 42 in response to turning of screw 43.

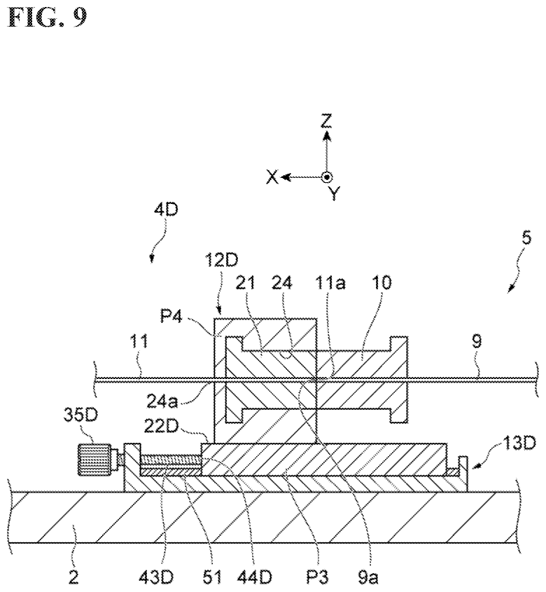

Referring to FIG. 9, an optical wiring component in a modification of the present embodiment will be described. FIG. 9 is a diagram illustrating the optical wiring component in the modification of the embodiment. This modification is generally similar to or the same as the modification described with reference to FIG. 8. An optical wiring component 4D in this modification is different from the above-described embodiment in that an optical connector 12D is included instead of optical connector 12C, a positioning member 13D is included instead of positioning member 13C, and a locking member 35D is included instead of locking member 35C. Hereinafter, differences between this modification and the above-described embodiment will be mainly described.

In this modification, optical connector 12D is configured to hold at least one optical fiber 11. Only one optical fiber 11 is shown in FIG. 9. However, a plurality of optical fibers 11 may be held by optical connector 12D. Optical connector 12D includes a changing mechanism 22D instead of changing mechanism 22C. Furthermore, in this modification, changing mechanism 22D is configured to restrict movement of optical connector 12D with respect to base 2 in the Y-axis direction and the Z-axis direction and enable movement of optical connector 12D with respect to base 2 in the X-axis direction. Changing mechanism 22D is configured to restrict movement of optical connector 12D with respect to positioning member 13D in the Y-axis direction and the Z-axis direction. Changing mechanism 22D is configured to enable relative movement of optical connector 12D with respect to positioning member 13D in the X-axis direction. In this modification, changing mechanism 22D is a housing and includes housing portion 24 that houses terminal member 21. Changing mechanism 22D may be integrally formed with terminal member 21.

Changing mechanism 22D is configured to slide in the X-axis direction with respect to positioning member 13D. Positioning member 13D includes a guide portion 51 configured to slide changing mechanism 22D. Guide portion 51 extends in the X-axis direction. In this modification, changing mechanism 22D is configured to come into contact with guide portion 51 and slide along guide portion 51 in the X-axis direction. A part P3 that slides with respect to positioning member 13D is formed separately from a part P4 having housing portion 24. These parts P3, P4 are joined to each other with, for example, an adhesive or a mechanical structure (not shown).

Locking member 35D is configured to lock movement of optical connector 12D with respect to positioning member 13D in the X-axis direction. Locking member 35D is configured to lock movement of optical connector 12D toward optical connection member 14 in the X-axis direction. In other words, locking member 35D is configured to lock movement of optical connector 12D in a direction in which optical fiber 11 extends from optical connector 12D.

Locking member 35D includes a screw 43D. Screw 43D is screwed into one of positioning member 13D and optical connector 12D. Screw 43D includes a tip 44D. Tip 44D is configured to move with respect to positioning member 13D and optical connector 12D in response to turning of screw 43D. Screw 43D extends in the X-axis direction. Tip 44D is configured to move in the X-axis direction in response to turning of screw 43D. Tip 44D is configured to engage with the other one of positioning member 13D and optical connector 12D and lock movement of optical connector 12D toward optical connection member 14.

In this modification, screw 43D is screwed into positioning member 13D. For example, a screw portion of screw 43D is in contact with positioning member 13D and extends through positioning member 13D to restrict movement of screw 43D. Tip 44D moves in the X-axis direction to come into contact with part P3 of changing mechanism 22D. Thus, screw 43D locks changing mechanism 22D at a position of tip 44D to be decided according to turning of screw 43D. As a result, the movement of optical connector 12D toward optical connection member 14 is locked. Terminal member 10 is configured to move together with optical connector 12D in a state in which end portion 9a of optical fiber 9 and end portion 11a of optical fiber 11 are optically connected.

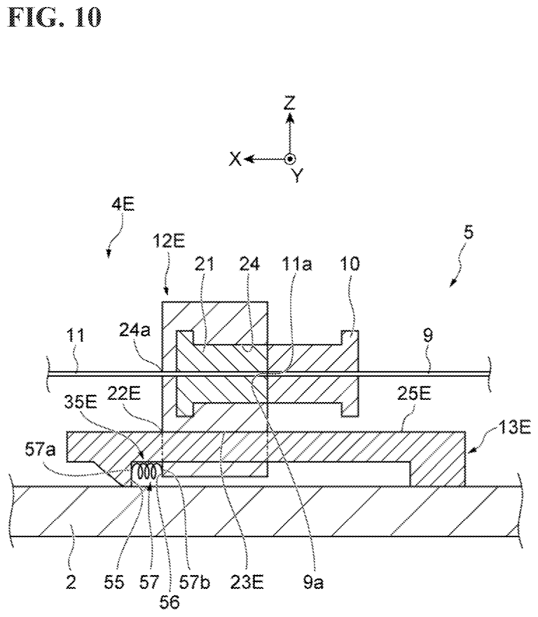

Referring to FIG. 10, an optical wiring component in a modification of the present embodiment will be described. FIG. 10 is a diagram illustrating the optical wiring component in the modification of the embodiment. This modification is generally similar to or the same as the modification described with reference to FIG. 3. An optical wiring component 4E in this modification is different from the above-described embodiment in that a positioning member 13E is included instead of positioning member 13, a changing mechanism 22E is included instead of changing mechanism 22, and a locking member 35E is further included. Hereinafter, differences between this modification and the above-described embodiment will be mainly described.

In this modification, an optical connector 12E is configured to hold at least one optical fiber 11. Only one optical fiber 11 is shown in FIG. 10. However, a plurality of optical fibers 11 may be held by optical connector 12E. Optical connector 12E includes changing mechanism 22E instead of changing mechanism 22.

Positioning member 13E is configured to position optical connector 12E with respect to base 2. Positioning member 13E is configured to engage with changing mechanism 22E of optical connector 12E. As shown in FIG. 10, positioning member 13E extends in the X-axis direction. Positioning member 13E has a rectangular shape when viewed in the Z-axis direction. Positioning member 13E includes a slide surface 25E extending in the X-axis direction when viewed in the Z-axis direction. Slide surface 25E is in contact with surface 23b of optical connector 12E and slides with respect to surface 23b. Slide surface 25E has, for example, a rectangular shape, and a longitudinal direction of slide surface 25E is parallel to the X-axis direction. In this modification, positioning member 13E is in contact with base 2. In this modification, positioning member 13E includes a support surface 55 facing optical connector 12E in the X-axis direction.

Changing mechanism 22E is configured to slide in the X-axis direction with respect to positioning member 13E. Changing mechanism 22E includes a through opening 23E extending through optical connector 12E in the X-axis direction. Positioning member 13E is fitted into through opening 23E. Changing mechanism 22E includes a contact surface 56 facing support surface 55 of positioning member 13E.

Locking member 35E includes an urging member 57. Urging member 57 is fixed to one of positioning member 13E and optical connector 12. Urging member 57 is configured to urge optical connector 12 in a direction in which optical connection member 14 and optical connector 12 separate from each other in the X-axis direction. In this modification, urging member 57 is, for example, a spring. The spring is, for example, a coil spring. One end 57a of the coil spring is, for example, fixed to support surface 55 of positioning member 13E. The other end 57b of the coil spring comes into contact with contact surface 56 of optical connector 12. Terminal member 10 is configured to move together with optical connector 12 in a state in which end portion 9a of optical fiber 9 and end portion 11a of optical fiber 11 are optically connected.

An urging force with which urging member 57 urges optical connector 12 is, for example, greater than a force applied to optical connector 12 by terminal member 10 in the X-axis direction when end portion 9a of optical fiber 9 and end portion 11a of optical fiber 11 are connected to each other. Urging member 57 is configured to urge optical connector 12 with an urging force of 5 N or more, for example.

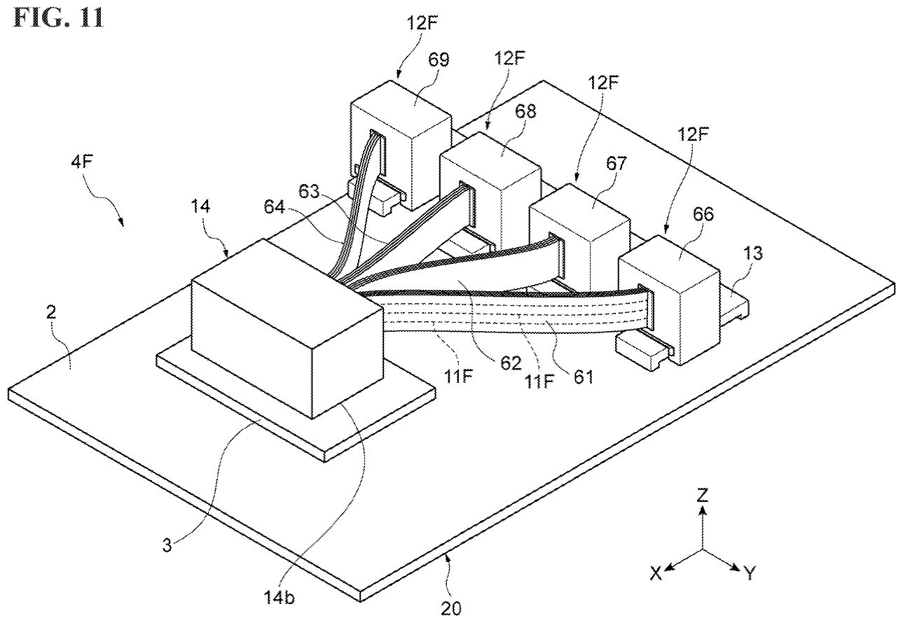

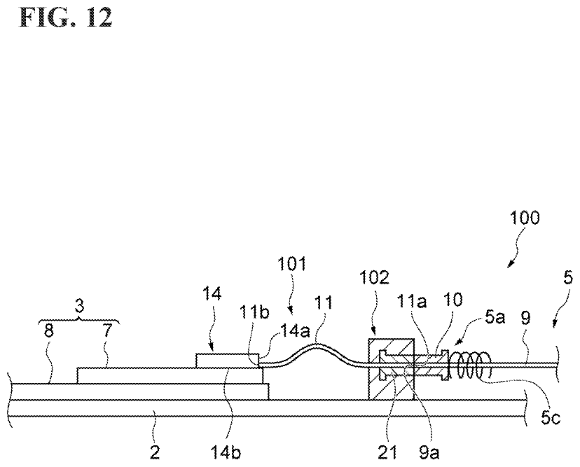

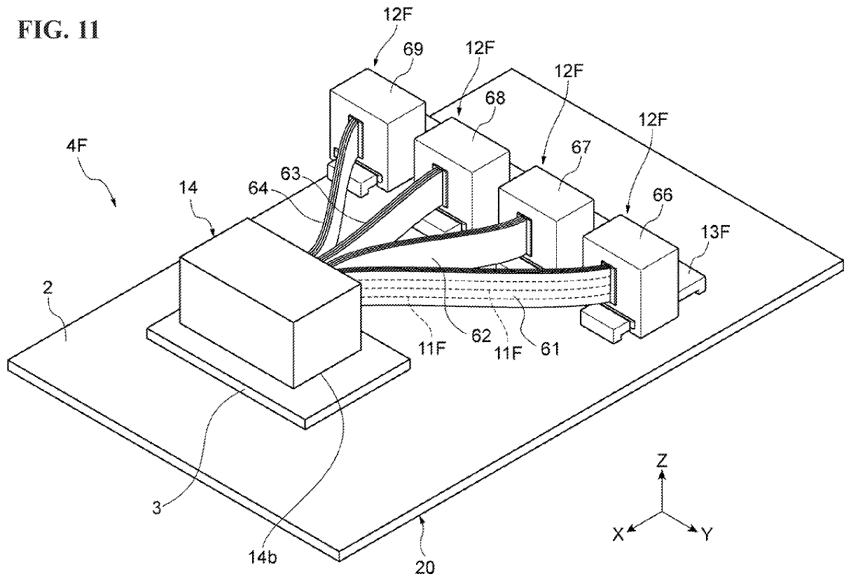

Referring to FIG. 11, an optical wiring component in a modification of the present embodiment will be described. FIG. 11 is a diagram illustrating the optical wiring component in the modification of the embodiment. This modification is generally similar to or the same as the modification described with reference to FIG. 3. An Optical wiring component 4F in this modification is different from the above-described embodiment in that a plurality of optical fibers 11F, a plurality of optical connectors 12F, and a plurality of positioning members 13F are included. Hereinafter, differences between this modification and the above-described embodiment will be mainly described.

Optical wiring component 4F includes an optical fiber group 61, 62, 63, and 64. Each of optical fiber groups 61 to 64 includes one or more optical fibers 11F. The one or more optical fibers 11F each include an end portion 11a and an end portion 11b in the same manner as optical fiber 11. In this modification, each of optical fiber groups 61 to 64 includes a plurality of optical fibers 11F extending parallel to one another. The plurality of optical connectors 12F include optical connectors 66, 67, 68, and 69. Optical connector 66 is configured to hold end portions 11a of the plurality of optical fibers 11F included in optical fiber group 61. An optical connector 67 is configured to hold end portions 11a of the plurality of optical fibers 11F included in optical fiber group 62. An optical connector 68 is configured to hold end portion 11a of the plurality of optical fibers 11F included in optical fiber group 63. An optical connector 69 is configured to hold end portions 11a of the plurality of optical fibers 11F included in optical fiber group 64. Optical connection member 14 is configured to hold respective end portions 11b of the plurality of optical fibers 11F included in optical fiber groups 61 to 64.

In the following, differences between optical wiring components 4, 4A, 4B, 4C, 4D, 4E, and 4F in the present embodiment and the modifications, and a comparative example will be described. FIG. 12 shows an optical device 100 as a comparative example. Optical device 100 includes an optical wiring component 101 instead of optical wiring component 4. Optical wiring component 101 includes an optical connector 102 instead of optical connector 12. Optical connector 102 includes no changing mechanism 22. In optical device 100, optical connection member 14 is joined to optical processor 7 of optical integrated circuit 3 at joint surface 14b. Optical connector 102 is directly fixed to base 2. In this case, the length of optical fiber 11 between optical connection member 14 and optical connector 102 needs an extra length to absorb a manufacturing error. However, the extra length causes the optical fiber fixed to the base by the optical connection member and the optical connector to be bent. When the curvature of the bending is large, the reliability of the optical coupling between the optical fiber and the circuit is lowered. In addition, a force generated by the bending of the optical fiber is applied to the connection portion between optical fiber 11 and optical connection member 14, and the connection portion between optical connection member 14 and optical integrated circuit 3. The force generated by the bending becomes larger as the length of optical fiber 11 becomes shorter.

In contrast, optical wiring component 4 includes changing mechanism 22. Changing mechanism 22 is configured to restrict the movement of optical connector with respect to the base in the Z-axis direction and the Y-axis direction and enable the movement of optical connector 12 with respect to base 2 in the X-axis direction. Therefore, even after optical connection member 14 and optical connector 12 are attached to base 2, the bending of optical fiber 11 can be eliminated by the movement of optical connector 12 in the X-axis direction by changing mechanism 22. Therefore, according to optical wiring component 4, the bending of the optical fiber can be reduced. Optical wiring components 4A, 4B, 4C, 4D, 4E, and 4F have the same configuration as that of optical wiring component 4, and the bending of optical fiber 11 can be reduced.

Optical device 1 includes optical wiring component 4, optical integrated circuit 3, and base 2. Optical integrated circuit 3 is optically connected to optical connection member 14. Optical integrated circuit 3 and optical wiring component 4 are disposed at base 2. Therefore, an influence of heat from optical integrated circuit 3 on optical connector 12 can be reduced, and the bending of optical fiber 11 can be reduced. By reducing the bending of optical fiber 11, the occurrence of failure of optical integrated circuit 3 due to the force generated by the bending of optical fiber 11 is reduced, and the reliability of optical coupling is improved as well.

Optical wiring component 4 includes positioning member 13. Positioning member 13 is configured to engage with changing mechanism 22 of optical connector 12 and position optical connector 12 with respect to base 2. Changing mechanism 22 is configured to restrict the movement of optical connector 12 with respect to positioning member 13 in the Z-axis direction and the Y-axis direction. Changing mechanism 22 is configured to enable the relative movement of optical connector 12 with respect to positioning member 13 in the X-axis direction. In this case, optical connector 12 can be easily and reliably positioned with respect to base 2 by positioning member 13, and the bending of optical fiber 11 can be eliminated by the movement of optical connector 12 in the X-axis direction. Optical wiring components 4A, 4B, 4C, 4D, 4E, and 4F also have the same configuration as optical wiring component 4.

Changing mechanism 22A and positioning member 13A include locking mechanism 31. Locking mechanism 31 is configured to lock the movement of optical connector 12A with respect to positioning member 13A. Locking mechanism 31 is configured to lock the movement of optical connector 12A toward optical connection member 14 in the X-axis direction. In this case, optical connector 12A can be fixed at a position where no bending of optical fiber 11 occurs.

Locking mechanism 31 includes a plurality of first claw portions 31a and second claw portion 31b. The plurality of first claw portions 31a are included in one of changing mechanism 22A and positioning member 13A. Second claw portion 31b is included in the other one of changing mechanism 22A and positioning member 13A. The plurality of first claw portions 31a are arranged in the X-axis direction. Second claw portion 31b is configured to restrict the movement of optical connector 12A with respect to positioning member 13A by coming into contact with any of the plurality of first claw portions 31a. In this case, a position at which optical connector 12A is locked changes according to the positional relationship between first claw portions 31a and second claw portion 31b which come into contact with each other. Therefore, optical connector 12A can be more reliably fixed at a position where no bending of optical fiber 11 occurs.

The plurality of first claw portions 31a and second claw portion 31b may be configured to restrict by coming into contact with each other the movement of optical connector 12A with respect to positioning member 13A in the direction toward optical connection member 14 and allow by sliding on each other the movement of optical connector 12A in the direction in which optical connection member 14 and optical connector 12A separate from each other. In this case, the movement of optical connector 12A in a direction in which the bending of optical fiber 11 is eliminated is allowed, while the movement of optical connector 12A in a direction in which the bending of optical fiber 11 occurs is restricted. Therefore, the bending of optical fiber 11 can be eliminated more easily and reliably.

Optical wiring component 4B includes locking member 35. Locking member 35 is configured to lock the movement of optical connector 12 with respect to positioning member 13B. Locking member 35 is configured to lock the movement of optical connector 12 toward optical connection member 14 in the X-axis direction. In this case, optical connector 12 can be fixed at a position where no bending of optical fiber 11 occurs. Optical wiring components 4C, 4D, and 4E also have the same configuration as optical wiring component 4B.

Locking member 35 of optical wiring component 4B includes pin member 36. Pin member 36 is fixed to one of positioning member 13B and optical connector 12. Pin member 36 is configured to, in a state of being fixed to one of positioning member 13B and optical connector 12, engage with the other one of positioning member 13B and optical connector 12 in the X-axis direction and lock the movement of optical connector 12 toward optical connection member 14. In this case, optical connector 12 can be fixed at a position where no bending of optical fiber 11 occurs by an easier operation.

Locking member 35C of optical wiring component 4C includes screw 43. Screw 43 is screwed into one of positioning member 13C and optical connector 12C. Screw 43 includes tip 44. Tip 44 is configured to move with respect to positioning member 13C and optical connector 12C in response to turning of screw 43. Tip 44 is configured to engage with the other one of positioning member 13C and optical connector 12C and lock the movement of optical connector 12C toward optical connection member 14. In this case, optical connector 12C can be fixed at a position where no bending of optical fiber 11 occurs by an easy operation using screw 43. Optical wiring component 4D has the same configuration as optical wiring component 4C.

Tip 44D of screw 43D of optical wiring component 4D is configured to move in the X-axis direction in response to turning of screw 43D. In this case, the fixing position of optical connector 12D can be adjusted, by turning screw 43D, with a higher precision to a position where no bending of optical fiber 11 occurs.

Locking member 35E of optical wiring component 4E includes urging member 57. Urging member 57 is screwed into one of positioning member 13E and optical connector 12E. Urging member 57 is configured to urge optical connector 12D in the direction in which optical connection member 14 and optical connector 12D separate from each other in the X-axis direction. In this case, an urging force of urging member 57 can reduce the occurrence of the bending of optical fiber 11 and reduce a force applied to the connection portion of optical connection member 14 due to the bending of optical fiber 11.

Optical connector 12 of optical wiring component 4 is configured to hold end portion 11a so that end portion 11a of optical fiber 11 extends in the X-axis direction in optical connector 12. In this case, adjusting the position of optical connector 12 in the X-axis direction can more reliably reduce the bending of optical fiber 11. Optical wiring components 4A, 4B, 4C, 4D, 4E, and 4F also have the same configuration as optical wiring component 4.

Optical wiring component 4F includes a plurality of optical fibers 11F and a plurality of optical connectors 12F. The plurality of optical connectors 12F include optical connectors 66, 67, 68, and 69. Optical connector 66 is configured to hold end portions 11a of optical fibers 11F included in optical fiber group 61. Optical connector 67 is configured to hold end portions 11a of optical fibers 11F included in optical fiber group 62. Optical connection member 14 is configured to hold respective end portions 11b of optical fibers 11F included in optical fiber group 61 and optical fiber group 62. In this case, the bending can be reduced in each of optical fibers 11F of different optical connectors 66 and 67 connected to one optical connection member 14.

Optical fibers 11 and 11F have a length of 20 mm to 100 mm. In this case, thermal influence on optical connectors 12 and 12F can be reduced, and a space for arranging optical wiring components 4 and 4F can be reduced. Therefore, the reliability of optical coupling can be improved by a compact configuration. Optical wiring components 4A, 4B, 4C, 4D, and 4E have the same configuration as optical wiring component 4F.

The embodiments have been described above. However, the present invention is not necessarily limited to the above-described embodiments, and various modifications can be made without departing from the scope of the present invention.

For example, optical wiring components 4, 4A, 4B, 4C, 4D, 4E, and 4F may include no positioning member. In this case, base 2 may include the positioning member. The positioning member and base 2 may be integrally formed.

The configurations in optical wiring components 4, 4A, 4B, 4C, 4D, 4E, and 4F may be combined with one another. For example, in optical wiring component 4A, pin member 36 may be provided as in optical wiring component 4B. In optical wiring component 4A, screws 43 and 43D may be provided as in optical wiring components 4C and 4D. In optical wiring component 4A, urging member 57 may be provided as in optical wiring component 4E. In optical wiring component 4B, screws 43 and 43D may be provided as in optical wiring components 4C and 4D. In optical wiring component 4B, urging member 57 may be provided as in optical wiring component 4E. Screw 43 of optical wiring component 4C and screw 43D of optical wiring component 4D may be provided together. In optical wiring component 4C, urging member 57 of optical wiring component 4E may be provided. In optical wiring component 4D, urging member 57 of optical wiring component 4E may be provided, and when screw 43D has a predetermined length or less, the urging force of urging member 57 may be applied to optical connector 12D.

The configurations in optical wiring components 4, 4A, 4B, 4C, 4D, and 4E and the configuration of an optical wiring component in which any configurations in optical wiring components 4, 4A, 4B, 4C, 4D, and 4E are combined to one another may be applied to optical wiring component 4F. In other words, each of optical connectors 66, 67, 68, and 69 of optical wiring component 4F may have any of the configurations in optical wiring components 4, 4A, 4B, 4C, 4D, and 4E or any combination of the configurations in optical wiring components 4, 4A, 4B, 4C, 4D, and 4E.

### REFERENCE SIGNS LIST

1 optical device
2 base
3 optical integrated circuit
4 optical wiring component
4A optical wiring component
4B optical wiring component
4C optical wiring component
4D optical wiring component
4E optical wiring component
4F optical wiring component
5 optical cable
5a end portion of optical cable
5b end portion of optical cable
5c urging member
7 optical processor
8 electrical processor
9 optical fiber
9a end portion of optical fiber 9
10 terminal member
11 optical fiber
11a end portion of optical fiber 11
11b end portion of optical fiber 11
11F optical fiber
12 optical connector
12A optical connector
12C optical connector
12D optical connector
12E optical connector
12F optical connector
13 positioning member
13A positioning member
13B positioning member
13C positioning member
13D positioning member
13E positioning member
13F positioning member
14 optical connection member
14a joint surface
14b joint surface
15 light reflection portion
21 terminal member
22 changing mechanism
22A changing mechanism
22C changing mechanism
22D changing mechanism
22E changing mechanism
23 through opening
23a surface
23b surface
23E through opening
24 housing portion
24a through hole
25 slide surface
25A slide surface
25E slide surface
26 curved portion
27 surface
31 locking mechanism
31a first claw portion
31b second claw portion
35 locking member
35C locking member
35D locking member
35E locking member
36 pin member
37 through opening
38 contact surface
41 rail
42 contact portion
43 screw
43D screw
44 tip
44D tip
51 guide portion
55 support surface
56 contact surface
57 urging member
57a one end
57b other end
61 optical fiber group
61 to 64 optical fiber groups
62 optical fiber group
63 optical fiber group
64 optical fiber group
66 optical connector
67 optical connector
68 optical connector
69 optical connector
100 optical device
101 optical wiring component
102 optical connector
P1 part
P2 part
P3 part
P4 part

1. An optical wiring component comprising:
an optical fiber having a first end portion and a second end portion, the optical fiber including one or a plurality of optical fibers;
an optical connector configured to be provided on a base and configured to hold the first end portion, the optical connector including one or a plurality of optical connectors; and
an optical connection member configured to hold the second end portion,
wherein the optical connector includes a terminal member configured to expose the first end portion, and a changing mechanism configured to restrict movement of the optical connector with respect to the base in a first direction and enable movement of the optical connector with respect to the base in a second direction intersecting the first direction.

2. The optical wiring component according to claim 1, further comprising:
a positioning member configured to engage with the changing mechanism of the optical connector and position the optical connector with respect to the base,
wherein the changing mechanism is configured to restrict movement of the optical connector with respect to the positioning member in the first direction and enable relative movement of the optical connector with respect to the positioning member in the second direction.

3. The optical wiring component according to claim 2,
wherein the changing mechanism and the positioning member further include a locking mechanism configured to lock movement of the optical connector with respect to the positioning member, and
wherein the locking mechanism is configured to lock movement of the optical connector toward the optical connection member in the second direction.

4. The optical wiring component according to claim 3,
wherein the locking mechanism includes a plurality of first claw portions included in one of the changing mechanism and the positioning member and a second claw portion included in another one of the changing mechanism and the positioning member,
wherein the plurality of first claw portions are arranged in the second direction, and
wherein the second claw portion is configured to restrict movement of the optical connector with respect to the positioning member by coming into contact with any of the plurality of first claw portions.

5. The optical wiring component according to claim 4, wherein the plurality of first claw portions and the second claw portion are configured to restrict by coming into contact with each other movement of the optical connector with respect to the positioning member in a direction toward the optical connection member and allow by sliding on each other movement of the optical connector in a direction in which the optical connection member and the optical connector separate from each other.

6. The optical wiring component according to claim 2, wherein the positioning member further includes a curved portion configured to be displaced in a third direction intersecting the first direction and the second direction.

7. The optical wiring component according to claim 2,
wherein the changing mechanism includes a through opening extending through the optical connector in the second direction, and
wherein the positioning member is fitted into the through opening and includes a slide surface configured to slide with respect to a surface defining the through opening.

8. The optical wiring component according to claim 2, further comprising:
a locking member configured to lock movement of the optical connector with respect to the positioning member,
wherein the locking member is configured to lock movement of the optical connector toward the optical connection member in the second direction.

9. The optical wiring component according to claim 8,
wherein the locking member includes a pin member fixed to one of the positioning member and the optical connector, and
wherein the pin member is configured to, in a state of being fixed to one of the positioning member and the optical connector, engage with another one of the positioning member and the optical connector in the second direction and lock movement of the optical connector toward the optical connection member.

10. The optical wiring component according to claim 8,
wherein the locking member includes a screw screwed into one of the positioning member and the optical connector,
wherein the screw includes a tip configured to move with respect to the positioning member and the optical connector in response to turning of the screw, and
wherein the tip is configured to engage with another one of the positioning member and the optical connector and lock movement of the optical connector toward the optical connection member.

11. The optical wiring component according to claim 10, wherein the tip is configured to move in the second direction in response to turning of the screw.

12. The optical wiring component according to claim 10, wherein the tip is configured to move in the first direction in response to turning of the screw.

13. The optical wiring component according to claim 8,
wherein the locking member includes an urging member fixed to one of the positioning member and the optical connector, and
wherein the urging member is configured to urge the optical connector in a direction in which the optical connection member and the optical connector separate from each other in the second direction.

14. The optical wiring component according to claim 13,
wherein the urging member includes a coil spring,
wherein the coil spring has one end fixed to one of the optical connector and the positioning member, and
wherein the coil spring has another end in contact with another one of the optical connector and the positioning member.

15. The optical wiring component according to claim 13, wherein the urging member is configured to urge the optical connector with an urging force of 5 N or more.

16. The optical wiring component according to claim 1, wherein the optical connector is configured to hold the first end portion of the optical fiber such that the first end portion extends in the second direction in the optical connector.

17. The optical wiring component according to claim 1,
wherein the one or plurality of optical fibers include a first optical fiber and a second optical fiber,
wherein the one or plurality of optical connectors include a first optical connector configured to hold the first end portion of the first optical fiber and a second optical connector configured to hold the first end portion of the second optical fiber, and
wherein the optical connection member is configured to hold the second end portion of each of the first optical fiber and the second optical fiber.

18. The optical wiring component according to claim 1, wherein the optical fiber has a length of 20 mm to 100 mm.

19. An optical device comprising:
the optical wiring component according to claim 1;
an optical integrated circuit optically connected to the optical connection member; and
a base at which the optical integrated circuit and the optical wiring component are disposed.

20. A method of assembling an optical device, the method comprising attaching the optical wiring component according to claim 1 to the base.
